(19) United States
(12) Patent Application Publication
(10) Pub. No.: US 2014/0257580 A1
(43) Pub. Date: Sep. 11, 2014

(54) POWER LINE CARRIER CONTROL MODULE

(71) Applicants: Chin Wen LIU, New Taipei City (TW); Kun-Hao Wu, Taipei City (TW)

(72) Inventors: Chin Wen LIU, New Taipei City (TW); Kun-Hao Wu, Taipei City (TW)

(21) Appl. No.: 13/790,914

(22) Filed: Mar. 8, 2013

(51) Int. Cl. G06F 1/26

(52) U.S. Cl. CPC G06F 1/26
USPC 700/286

(57) ABSTRACT

A power line carrier control module includes a microcontroller, an optical coupling isolation unit, a digital input unit, a buffer unit, a digital output unit, an analog-to-digital conversion (ADC) unit, an analog input unit, a digital-to-analog conversion (DAC) unit, an analog output unit, a first power line carrier module and a second power line carrier module. The power line carrier control module can be applied to power line carrier controllers in fields of street light control or industrial control to achieve effects of cross-phase and cross-meter operations in AC 12V to 440V power loops.

### FIELD OF THE INVENTION

The present invention relates to a power line carrier control module, and particularly to a power line carrier control module operable in a simultaneous duplex master-slave mode.

### BACKGROUND OF THE INVENTION

A power line carrier is a communication transmission technology based on a current AC power loop. Being free of a line spreading process, the power line carrier prevails in applications including cable anti-theft, lighting control as well industrial applications such as pan-tilt-zoom (PTZ) cameras of monitoring systems and motor control.

The power line carrier yet faces various technical bottlenecks to be solved. Firstly, in the presence of a heavy load, the power line provides a short transmission distance. In the prior art, a repeater is connected in series between power lines to achieve amplified signals. However, such approach contradicts with conveniences offered by a loop while also increasing the cost.

Further, a distribution transformer imposes an isolation effect on power line carrier signals. Thus, instead of interconnecting among different power loops, power line carrier signals can only be transmitted within a range of one distribution transformer. In addition, in the event of a short communication distance, signals of different phases may be mutually interfered. The common household electricity, 220VAC, is divided into two phases each of which is 110VAC. Signals of the two phases cannot be connected in a way the power line carrier signals can only be transmitted on a single-phase power line. As such, not only an application scope of the power line carrier is limited but also application stability is degraded.

### SUMMARY OF THE INVENTION

Therefore the primary object of the present invention is to provide a power line carrier control module operable in a simultaneous duplex master-slave mode.

A power line carrier control module is provided by the present invention. The power line carrier control module includes a microcontroller which comprises a first connection port unit, a second connection port unit, a first communication unit, a second communication unit and a bus unit; an optical coupling isolation unit which is electrically connected to the first connection port unit; a digital input unit which is electrically connected to the optical coupling isolation unit; a buffer unit which is electrically connected to the second connection port unit; a digital output unit which is electrically connected to the buffer unit; an analog-to-digital conversion (ADC) unit which is electrically connected to the bus unit; an analog input unit which is electrically connected to the ADC unit; a digital-to-analog conversion (DAC) unit which is electrically connected to the bus unit; an analog output unit which is electrically connected to the DAC unit; a first power line carrier module which is electrically connected to first communication unit, a first power line loop and a second power line loop; and a second power line carrier module which is electrically connected to the second communication unit, the first power line loop and the second power line loop as well as the first power line carrier module.

The power line carrier control module of the present invention, operable through power line modules of different frequencies, offers the advantages below. First of all, the power line carrier control module may simultaneously serve as a master and a slave, and can be connected in parallel for easy management to offer effective and shortened management time or connected in series to provide long-distance transmission. Secondly, the power line carrier control module is capable of cross-phase and cross-meter operations. Further, the power line carrier control module has a voltage range suitable for industrial specifications adaptable to industrial automated control.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of the present. invention.

### DETAILED DESCRIPTION OF THE PREFERRED EMBODIMENTS

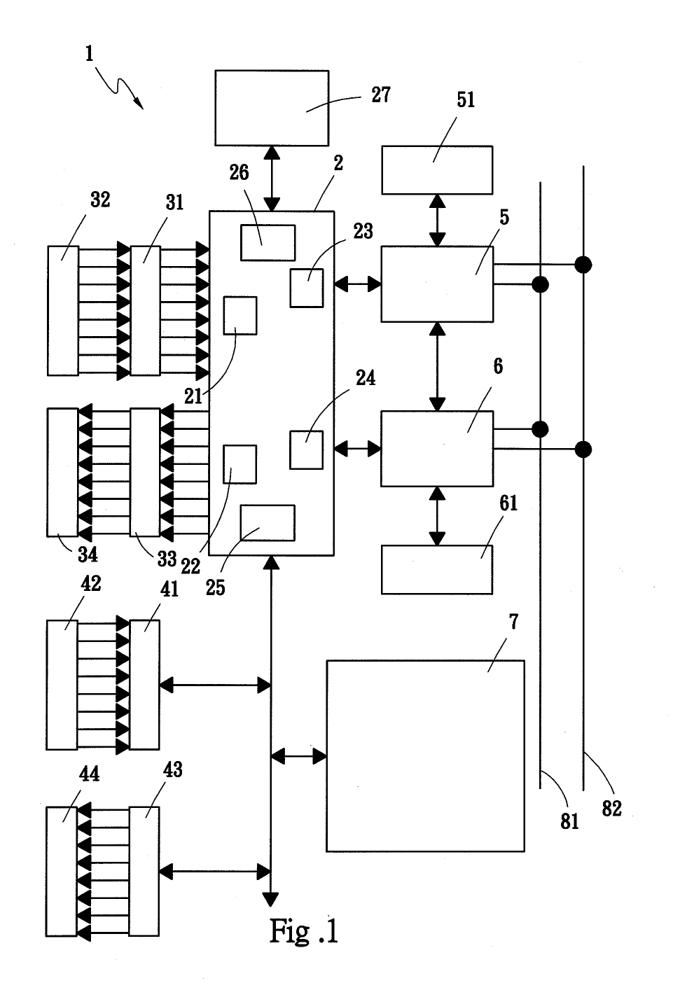

FIG. 1 shows a power line carrier control module 1 according to one embodiment of the present invention. The power line carrier control module 1 comprises a microcontroller 2, an optical coupling isolation unit 31, a digital input unit 32, a buffer unit 33, a digital output unit 34, an analog-to-digital conversion (ADC) unit 41, an analog input unit 42, a digital-to-analog conversion (DAC) unit 43, an analog output unit 44, a first power line carrier module 5, and a second power line carrier module 6.

With reference to FIG. 1, connection relations of the units of the power line carrier control module 1 of the present invention are described below by taking an application of street light control for example. The microcontroller 2 comprise a first connection port unit 21, a second connection port unit 22, a first communication unit 23 and a second communication unit 24 which can be Universal Asynchronous Receiver/Transmitter (UART) communication interface (e.g., RS-232 or RS-485), and a bus unit 25 which can be Serial Peripheral Interface (SPI) interface.

The digital input unit 32 is electrically connected to the optical coupling isolation unit 31 which is further electrically connected to the first connection port unit 21. The digital input unit 32 is capable of detecting the on/off status of a street light, and inputs a status signal of the street light via the optical coupling isolation unit 31 to the first connection port unit 21.

The buffer unit 33 is electrically connected to the second connection port unit 22. The digital output unit 34 is electrically connected to the buffer unit 33, such that the microcontroller 2 outputs a control signal to the digital output unit 34 via the buffer unit 33 to control on/off of the light.

The ADC unit 41 is electrically connected to the bus 25 unit, and the analog input unit 42 is electrically connected to the ADC unit 41. For example, the analog input unit 42 detects the temperature or brightness of light, and the ADC unit 41 converts an analog signal representing the temperature or brightness of the light to a digital signal. The digital signal is inputted into the microcontroller 2 via the bus unit 25.

The DAC unit 43 is electrically connected to the bus unit 25, and the analog output unit 44 is electrically connected to the DAC unit 43. The microcontroller 2 outputs a digital signal via the bus unit 25, and the digital signal is converted to an analog signal by the DAC unit 43 and outputted to the analog output unit 44 to control the brightness of the light. The bus unit 25 connects to an interface adaptor unit 7 which further connects to another UART interface (e.g., RS-232 or RS-485) for data conversion. Accordingly, a user is allowed to control the present invention via a computer to monitor and control the street light.

The first power line carrier module 5 is electrically connected to the first communication unit 23, a first power line loop 81 and a second power line loop 82. The second power line carrier module 6 is electrically connected to the second communication unit 24, the first power line loop 81 and the second power line loop 82. Further, the second power line loop 6 is also electrically connected to the first power line loop 5. The first power line loop 81 and the second power line loop 82 are different and have a voltage range of AC 12V to 440V, and respectively are electrically connected to a 16-bit addressing unit 51 and 61, so that cyclic redundancy check (CRC) operations of 16-bit precision can be performed.

The microcontroller 2 further comprises an input/output unit 26. The input/output unit 26 is connected to a repeater unit 27 for amplifying a signal.

In a communication control approach of the present invention, assume that the first power line carrier module 5 operates at a frequency of 115 kHz serves as a master, and the second power line carrier module 6 operates at a frequency of 76 kHz serves as a slave. Thus, the first power line carrier module 5 and the second power line carrier module 6 are capable of simultaneously operating at different operating frequencies without requiring extra modulation. With an additional application of Modbus communication protocol, the first power line carrier module 5 and the second power line carrier module 6 are capable of simultaneous half-duplex operations in a master-slave mode. In other words, a single power line control module is capable of simultaneously serving as a master (regarded for control and communication purposes) and a slave (regarded for repeater for street lights). Assuming that one master manages ten slaves in an original situation, the situation may be changed to two parallel sets, each with one master managing five slaves, thereby shorting the control time. Alternatively, the situation may be change to a master managing two slaves, with one of the slaves serving as a master that connects the remaining seven slaves in series for serial management.

In continuation of the above descriptions, the first power line carrier module 5 and the second power line carrier module 6 operate at different operating frequencies. Therefore, a breakthrough is provided for an innate technical restriction of the power line carrier technology by disposing the first power line carrier module 5 and the second power line carrier module 6 on different electric meter sections of the power line loop or different phase sections of the power line loop. Thus the dual-core module is allowed to operate simultaneously to achieve cross-meter and cross-phase operation effects.

With the above descriptions, it is demonstrated that the power line carrier control module of the present invention is applicable to power line carrier controllers in various fields including household automation, remote curtain control, cable anti-theft, street light management systems, electric meter recording systems, electronic billboards and industrial control, thereby achieving cross-phase and cross-meter operation effects in AC 12V to 440V power loops.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A power line carrier control module, comprising:
a microcontroller, comprising a first connection port unit, a second connection port unit, a first communication unit, a second communication unit and a bus unit;
an optical coupling isolation unit, electrically connected to the first connection port unit;
a digital input unit, electrically connected to the optical coupling isolation unit;
a buffer unit, electrically connected to the second connection port unit;
a digital output unit, electrically connected to the buffer unit;
an analog-to-digital conversion unit, electrically connected to the bus unit;
an analog input unit, electrically connected to the analog-to-digital conversion unit;
a digital-to-analog conversion unit, electrically connected to the bus unit;
an analog output unit, electrically connected to the digital-to-analog conversion unit;
a first power line carrier module, electrically connected to the first communication unit, a first power line loop and a second power line loop; and
a second power line carrier module, electrically connected to the second communication unit, the first power line loop, the second power line loop and the first power line carrier module.

2. The power line carrier control module of claim 1, wherein the microcontroller further comprises an input/output unit connected to a repeater unit.

3. The power line carrier control module of claim 1, wherein the first power line loop and the second power line loop are different and have a voltage range of AC 12V to 440V.

4. The power line carrier control module of claim 1, wherein the first communication unit and the second communication unit are Universal Asynchronous Receiver/Transmitter (UART) communication interface.

5. The power line carrier control module of claim 4, wherein the Universal Asynchronous Receiver/Transmitter (UART) communication interface is RS-232 or RS-485.

6. The power line carrier control module of claim 1, further comprising an interface adaptor unit electrically connected to the bus unit.

7. The power line carrier control module of claim 6, wherein the bus unit is electrically connected to Universal Asynchronous Receiver/Transmitter (UART) communication interface through the interface adaptor unit for data conversion.

8. The power line carrier control module of claim 7, wherein the Universal Asynchronous Receiver/Transmitter (UART) communication interface is RS-232 or RS-485.

9. The power line carrier control module of claim 1, wherein the bus unit is a Serial Peripheral Interface (SPI) interface.

10. The power line carrier control module of claim 1, wherein the first power line carrier module and the second power line carrier module respectively are electrically connected to a 16-bit addressing unit.
